(19) United States
(12) Patent Application Publication
(10) Pub. No.: US 2025/0265185 A1
(43) Pub. Date: Aug. 21, 2025

(54) Data Storage Device and Method for Using an Adaptive, Configurable Storage Indirection Unit

(71) Applicant: Western Digital Technologies, Inc., San Jose, CA (US)

(72) Inventors: Avichay Hodes, Kfar Ben Nun (IL); Judah Gamliel Hahn, Ofra (IL); Alexander Bazarsky, Holon (IL)

(73) Assignee: Western Digital Technologies, Inc., San Jose, CA (US)

(21) Appl. No.: 18/442,624

(22) Filed: Feb. 15, 2024

(51) Int. Cl. G06F 12/02; G06F 12/06

(52) U.S. Cl. CPC G06F 12/0246; G06F 12/0653; G06F 2212/7201

(57) ABSTRACT

A data storage device and method for using an adaptive, configurable storage indirection unit are disclosed. In one embodiment, a data storage device is provided comprising a memory and one or more processors. The one or more processors, individually or in combination, are configured to: receive, from a host, a request to change a size of an indirection unit for at least a part of the memory; and in response to receiving the request, change the size of the indirection unit for the at least the part of the memory. Other embodiments are disclosed.

### BACKGROUND

A host can store data in and/or read data from a memory in a data storage device. The host can specify a logical address from which the data is to be stored, and the data storage device can use a logical-to-physical address map to translate that logical address to a physical address of a location in the memory. The amount (size) of data written to the logical address is sometimes referred to as an “indirection unit” and is typically hard-coded in the data storage device during production and used for the entire lifetime of the data storage device.

### BRIEF DESCRIPTION OF THE DRAWINGS

FIG. 1A is a block diagram of a data storage device of an embodiment.

FIG. 1B is a block diagram illustrating a storage module of an embodiment.

FIG. 1C is a block diagram illustrating a hierarchical storage system of an embodiment.

FIG. 2A is a block diagram illustrating components of the controller of the data storage device illustrated in FIG. 1A according to an embodiment.

FIG. 2B is a block diagram illustrating components of the data storage device illustrated in FIG. 1A according to an embodiment.

FIG. 3 is a block diagram of a host and a data storage device of an embodiment.

FIG. 4 is a block diagram of an example architecture of an embodiment.

FIG. 5 is a flow chart of a method of an embodiment for using an adaptive, configurable storage indirection unit.

FIG. 6 is a flow chart of a method of an embodiment for performing indirection unit allocation in a loop.

FIG. 7 is a flow chart of a dynamic random-access memory (DRAM) reallocation process of an embodiment.

### DETAILED DESCRIPTION

The following embodiments generally relate to a data storage device and method for using an adaptive, configurable storage indirection unit. In one embodiment, a data storage device is provided comprising a memory and one or more processors. The one or more processors, individually or in combination, are configured to: receive, from a host, a request to change a size of an indirection unit for at least a part of the memory; and in response to receiving the request, change the size of the indirection unit for the at least the part of the memory.

In some embodiments, the one or more processors, individually or in combination, are further configured to use different indirection units in different parts of the memory at a given time.

In some embodiments, the at least the part of the memory comprises a namespace.

In some embodiments, the one or more processors, individually or in combination, are further configured to provide the host with a plurality of sizes of the indirection unit for selection.

In some embodiments, changing the size of the indirection unit increases a size of a logical-to-physical address map, and the one or more processors, individually or in combination, are further configured to track the size of the logical-to-physical address map and prevent the size of the logical-to-physical address map from exceeding a limit.

In some embodiments, the size of the indirection unit for the at least the part of the memory is constrained by an amount of volatile memory available to store a logical-to-physical address map.

In some embodiments, the one or more processors, individually or in combination, are further configured to: read at least a portion of a logical-to-physical address map; and store the at least a portion of a logical-to-physical address map in volatile memory in the data storage device and/or in volatile memory in the host.

In some embodiments, the one or more processors, individually or in combination, are further configured to: store at least a portion of a logical-to-physical address map in volatile memory; determine whether all of a plurality of namespaces have been allocated; in response to determining that all of the plurality of namespaces have been allocated, allocate remaining volatile memory for use by the one or more processors; and in response to determining that all of the plurality of namespaces have not been allocated, allocate an indirection unit for a next namespace, considering at least one of a remaining size of the volatile memory, a namespace type, and/or remaining namespace(s).

In some embodiments, the indirection unit comprises a minimal recommended write unit size.

In some embodiments, different sizes of indirection units are used for logs and host data.

In some embodiments, the memory comprises a three-dimensional memory.

In another embodiment, a method is performed in a data storage device comprising a memory. The method comprises: providing a host with a plurality of choices for a definition of an amount of data written to or read from a logical address in at least a part of the memory; receiving, from the host, a selection of one of the plurality of choices; and in response to receiving the selection, changing the definition of the amount of data based on the selection.

In some embodiments, the method further comprises: after the definition of the amount of data has been changed, updating the plurality of choices based, at least in part, on availability of volatile memory in the data storage device and/or host to store at least a portion of a logical-to-physical address map.

In some embodiments, the method further comprises: performing a loop in which a definition of an amount of data written to or read from a logical address in each of a plurality of other parts of the memory is changed, wherein the definitions of the amounts of data for the plurality of other parts of the memory are each determined based on an amount of volatile memory available to store at least a part of a logical-to-physical address map.

In some embodiments, the method further comprises: after the definition of the amount of data has been changed: storing at least a portion of a logical-to-physical address map in volatile memory, wherein a size of the at least the portion of the logical-to-physical address map depends on the definition of the amount of data; and using remaining space in the volatile memory for storing data other than portions of the logical-to-physical address map.

In some embodiments, the amount of data written to or read from the logical address comprises an indirection unit.

In some embodiments, the indirection unit comprises a minimal recommended write unit size.

In some embodiments, the method further comprises using different sizes of indirection units for logs and host data.

In some embodiments, the method further comprises: allocating volatile memory; generating an estimate of an amount of volatile memory needed to store at least a portion of a logical-to-physical address map; re-allocating the volatile memory based on the estimate; and allowing remaining space in the volatile memory to be used for a purpose other than logical-to-physical address-map storage. In another embodiment, a data storage device is provided comprising: a memory; and means for re-configuring a size of a storage indirection unit after production of the data storage device, wherein the size of the storage indirection unit is not hard-coded in the data storage device.

Other embodiments are possible, and each of the embodiments can be used alone or together in combination. Accordingly, various embodiments will now be described with reference to the attached drawings.

### Embodiments

The following embodiments relate to a data storage device (DSD). As used herein, a “data storage device” refers to a non-volatile device that stores data. Examples of DSDs include, but are not limited to, hard disk drives (HDDs), solid state drives (SSDs), tape drives, hybrid drives, etc. Details of example DSDs are provided below.

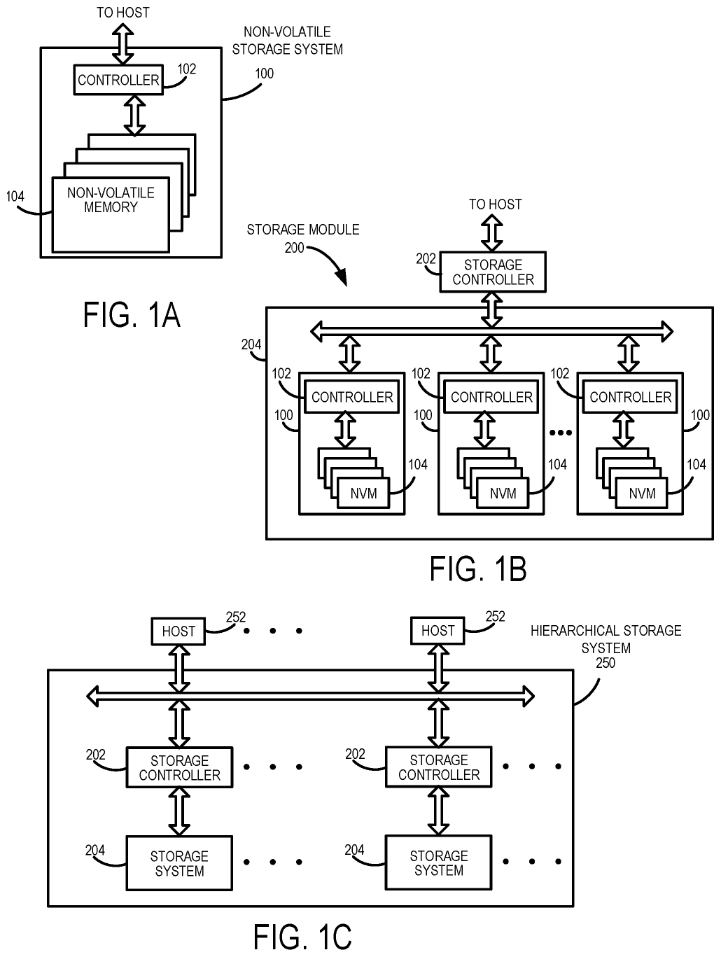

Examples of data storage devices suitable for use in implementing aspects of these embodiments are shown in FIGS. 1A-1C. It should be noted that these are merely examples and that other implementations can be used. FIG. 1A is a block diagram illustrating the data storage device 100 according to an embodiment. Referring to FIG. 1A, the data storage device 100 in this example includes a controller 102 coupled with a non-volatile memory that may be made up of one or more non-volatile memory die 104. As used herein, the term die refers to the collection of non-volatile memory cells, and associated circuitry for managing the physical operation of those non-volatile memory cells, that are formed on a single semiconductor substrate. The controller 102 interfaces with a host system and transmits command sequences for read, program, and erase operations to non-volatile memory die 104. Also, as used herein, the phrase “in communication with” or “coupled with” could mean directly in communication/coupled with or indirectly in communication/coupled with through one or more components, which may or may not be shown or described herein. The communication/coupling can be wired or wireless.

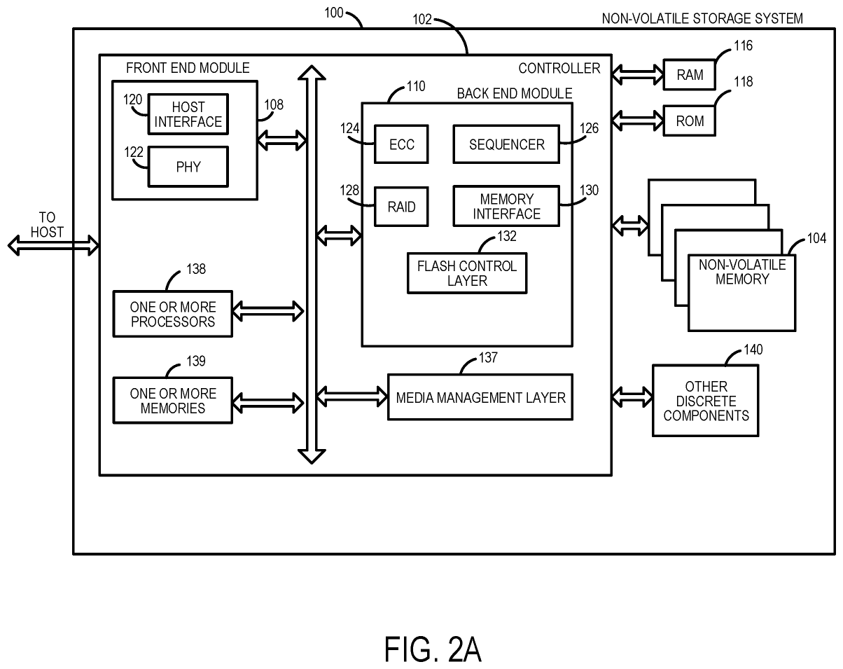

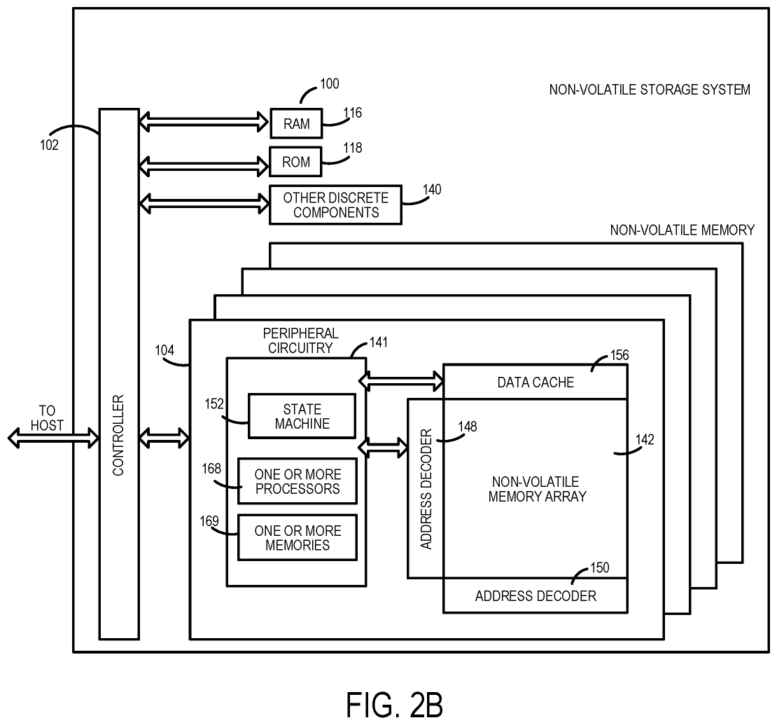

The controller 102 (which may be a non-volatile memory controller (e.g., a flash, resistive random-access memory (ReRAM), phase-change memory (PCM), or magnetoresistive random-access memory (MRAM) controller)) can include one or more components, individually or in combination, configured to perform certain functions, including, but not limited to, the functions described herein and illustrated in the flow charts. For example, as shown in FIG. 2A, the controller 102 can comprise one or more processors 138 that are, individually or in combination, configured to perform functions, such as, but not limited to the functions described herein and illustrated in the flow charts, by executing computer-readable program code stored in one or more non-transitory memories 139 inside the controller 102 and/or outside the controller 102 (e.g., in random access memory (RAM) 116 or read-only memory (ROM) 118). As another example, the one or more components can include circuitry, such as, but not limited to, logic gates, switches, an application specific integrated circuit (ASIC), a programmable logic controller, and an embedded microcontroller.

In one example embodiment, the non-volatile memory controller 102 is a device that manages data stored on non-volatile memory and communicates with a host, such as a computer or electronic device, with any suitable operating system. The non-volatile memory controller 102 can have various functionality in addition to the specific functionality described herein. For example, the non-volatile memory controller can format the non-volatile memory to ensure the memory is operating properly, map out bad non-volatile memory cells, and allocate spare cells to be substituted for future failed cells. Some part of the spare cells can be used to hold firmware (and/or other metadata used for housekeeping and tracking) to operate the non-volatile memory controller and implement other features. In operation, when a host needs to read data from or write data to the non-volatile memory, it can communicate with the non-volatile memory controller. If the host provides a logical address to which data is to be read/written, the non-volatile memory controller can convert the logical address received from the host to a physical address in the non-volatile memory. The non-volatile memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including resistive random-access memory (ReRAM), magnetoresistive random-access memory (MRAM), phase-change memory (PCM), NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC) (e.g., dual-level cells, triple-level cells (TLC), quad-level cells (QLC), etc.) or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, the data storage device 100 may be a card-based system, such as a secure digital (SD) or a micro secure digital (micro-SD) card. In an alternate embodiment, the data storage device 100 may be part of an embedded data storage device.

Although, in the example illustrated in FIG. 1A, the data storage device 100 (sometimes referred to herein as a storage module) includes a single channel between controller 102 and non-volatile memory die 104, the subject matter described herein is not limited to having a single memory channel. For example, in some architectures (such as the ones shown in FIGS. 1B and 1C), two, four, eight or more memory channels may exist between the controller and the memory device, depending on controller capabilities. In any of the embodiments described herein, more than a single channel may exist between the controller and the memory die, even if a single channel is shown in the drawings.

FIG. 1B illustrates a storage module 200 that includes plural non-volatile data storage devices 100. As such, storage module 200 may include a storage controller 202 that interfaces with a host and with data storage device 204, which includes a plurality of data storage devices 100. The interface between storage controller 202 and data storage devices 100 may be a bus interface, such as a serial advanced technology attachment (SATA), peripheral component interconnect express (PCIe) interface, double-data-rate (DDR) interface, or serial attached small scale compute interface (SAS/SCSI). Storage module 200, in one embodiment, may be a solid-state drive (SSD), or non-volatile dual in-line memory module (NVDIMM), such as found in server PC or portable computing devices, such as laptop computers, and tablet computers.

FIG. 1C is a block diagram illustrating a hierarchical storage system. A hierarchical storage system 250 includes a plurality of storage controllers 202, each of which controls a respective data storage device 204. Host systems 252 may access memories within the storage system 250 via a bus interface. In one embodiment, the bus interface may be a Non-Volatile Memory Express (NVMe) or Fibre Channel over Ethernet (FCoE) interface. In one embodiment, the system illustrated in FIG. 1C may be a rack mountable mass storage system that is accessible by multiple host computers, such as would be found in a data center or other location where mass storage is needed.

Referring again to FIG. 2A, the controller 102 in this example also includes a front-end module 108 that interfaces with a host, a back-end module 110 that interfaces with the one or more non-volatile memory die 104, and various other components or modules, such as, but not limited to, a buffer manager/bus controller module that manage buffers in RAM 116 and controls the internal bus arbitration of controller 102. A module can include one or more processors or components, as discussed above. The ROM 118 can store system boot code. Although illustrated in FIG. 2A as located separately from the controller 102, in other embodiments one or both of the RAM 116 and ROM 118 may be located within the controller 102. In yet other embodiments, portions of RAM 116 and ROM 118 may be located both within the controller 102 and outside the controller 102.

Front-end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, serially attached small computer system interface (SAS), Fibre Channel, universal serial bus (USB), PCIe, and NVMe. The host interface 120 typically facilitates transfer for data, control signals, and timing signals.

Back-end module 110 includes an error correction code (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the memory device 104. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. The controller 102 in this example also comprises a media management layer 137 and a flash control layer 132, which controls the overall operation of back-end module 110.

The data storage device 100 also includes other discrete components 140, such as external electrical interfaces, external RAM, resistors, capacitors, or other components that may interface with controller 102. In alternative embodiments, one or more of the physical layer interface 122, RAID module 128, media management layer 138 and buffer management/bus controller 114 are optional components that are not necessary in the controller 102.

FIG. 2B is a block diagram illustrating components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including ReRAM, MRAM, PCM, NAND flash memory cells and/or NOR flash memory cells in a two-dimensional and/or three-dimensional configuration. Non-volatile memory die 104 further includes a data cache 156 that caches data. The peripheral circuitry 141 in this example includes a state machine 152 that provides status information to the controller 102. The peripheral circuitry 141 can also comprise one or more components that are, individually or in combination, configured to perform certain functions, including, but not limited to, the functions described herein and illustrated in the flow charts. For example, as shown in FIG. 2B, the memory die 104 can comprise one or more processors 168 that are, individually or in combination, configured to execute computer-readable program code stored in one or more non-transitory memories 169, stored in the memory array 142, or stored outside the memory die 104. As another example, the one or more components can include circuitry, such as, but not limited to, logic gates, switches, an application specific integrated circuit (ASIC), a programmable logic controller, and an embedded microcontroller.

In addition to or instead of the one or more processors 138 (or, more generally, components) in the controller 102 and the one or more processors 168 (or, more generally, components) in the memory die 104, the data storage device 100 can comprise another set of one or more processors (or, more generally, components). In general, wherever they are located and however many there are, one or more processors (or, more generally, components) in the data storage device 100 can be, individually or in combination, configured to perform various functions, including, but not limited to, the functions described herein and illustrated in the flow charts. For example, the one or more processors (or components) can be in the controller 102, memory device 104, and/or other location in the data storage device 100. Also, different functions can be performed using different processors (or components) or combinations of processors (or components). Further, means for performing a function can be implemented with a controller comprising one or more components (e.g., processors or the other components described above).

Returning again to FIG. 2A, the flash control layer 132 (which will be referred to herein as the flash translation layer (FTL) handles flash errors and interfaces with the host. In particular, the FTL, which may be an algorithm in firmware, is responsible for the internals of memory management and translates writes from the host into writes to the memory 104. The FTL may be needed because the memory 104 may have limited endurance, may be written in only multiples of pages, and/or may not be written unless it is erased as a block. The FTL understands these potential limitations of the memory 104, which may not be visible to the host. Accordingly, the FTL attempts to translate the writes from host into writes into the memory 104.

The FTL may include a logical-to-physical address (L2P or LTP) map (sometimes referred to herein as a table or data structure) and allotted cache memory. In this way, the FTL translates logical block addresses (“LBAs”) from the host to physical addresses in the memory 104. The FTL can include other features, such as, but not limited to, power-off recovery (so that the data structures of the FTL can be recovered in the event of a sudden power loss) and wear leveling (so that the wear across memory blocks is even to prevent certain blocks from excessive wear, which would result in a greater chance of failure).

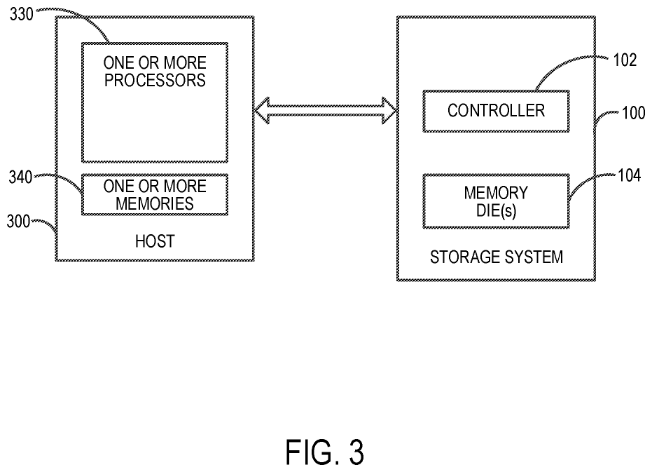

Turning again to the drawings, FIG. 3 is a block diagram of a host 300 and data storage device 100 of an embodiment. The host 300 can take any suitable form, including, but not limited to, a computer, a mobile phone, a tablet, a wearable device, a digital video recorder, a surveillance system, etc. The host 300 in this embodiment (here, a computing device) comprises one or more processors 330 and one or more memories 340. In one embodiment, computer-readable program code stored in the one or more memories 340 configures the one or more processors 330 to perform the acts described herein as being performed by the host 300. So, actions performed by the host 300 are sometimes referred to herein as being performed by an application (computer-readable program code) run on the host 300. For example, the host 300 can be configured to send data (e.g., initially stored in the host's memory 340) to the data storage device 100 for storage in the data storage device's memory 104.

As mentioned above, the controller 102 can use a logical-to-physical (“L2P” to “LTP”) address map to translate a logical address from the host 300 to a physical address of a location in the memory 104. An “indirection unit (IU)” can refer to an amount (size) of data written to a logical address. For example, an indirection unit can be the minimal recommended write unit size for a regular flash/solid state device (SSD). Four kilobytes (4KB) is a common indirection unit for enterprise SSDs, personal computer SSDs, and removable data storage devices (e.g., memory cards or sticks).

In some enterprise SSDs, a larger indirection unit (e.g., 16KB or 32KB) is used to allow for better cost and area efficiency. However, a larger indirection unit can have a significant impact on the size of the addressing logical-to-physical address map. For example, with an indirection unit of 4KB, the logical-to-physical address map can have four bytes (4B) of addressing data for each 4KB of user data, and the logical-to-physical address map can be loaded to a dedicated volatile memory (e.g., DRAM memory). This translates into a logical-to-physical address map that is of a size proportional to the total memory capacity divided by 1,000. However, if the indirection unit is 16KB, the logical-to-physical address map can contain 4B for each 16KB, which reduces the size of the logical-to-physical address map by four.

In order to reduce read latency, the logical-to-physical address map (in its entirety or a portion of it) can be read from the non-volatile memory 104 and stored in volatile memory for faster read access. Examples of the volatile memory can include, but are not limited to, RAM 116 (e.g., dynamic RAM (DRAM)) in the data storage device 100, a host memory buffer (HMB) (e.g., part of the one or more memories 340 in the host 300), and/or combinations thereof (e.g., part of the logical-to-physical address map being stored in DRAM 116 in the data storage device 100 and another part of the logical-to-physical address map stored in the host memory buffer in the host 300). The size of the indirection unit can impact the amount of volatile memory is needed to store it. More specifically, having a larger indirection unit can have the benefit of reducing the total size of the volatile memory needed to store the map or can increase performance that is achieved with available volatile memory.

In some prior data storage devices, the indirection unit is hard-coded in the storage controller during production and is applied for the entire lifetime of the data storage device. However, a host client may sometimes want to use a different (e.g., larger) indirection unit for some of its data (but not for the entire device). A hard-coded indirection unit prevents this flexibility.

The following embodiments address this problem by providing an adaptive, configurable indirection unit that can be configured after production (e.g., in the field), which can be applied to the entirety of the memory 102 or to just a part of the memory 104 (a “device section”), so that different indirection units can be used in different parts of the memory 104 at a given time. The indirection unit can be configured in any suitable way. For example, in one embodiment, the indirection unit is selected by the host 300 (e.g., from a list of possible indirection units provided by the controller 102). In other embodiment, the controller 102 of the data storage device or some other entity configures the indirection unit. With these embodiments, the definition of an amount of data written to or read from a logical address in at least a part of the memory can be changed and is not hard-coded in the data storage device.

In some embodiments, the part of the memory 104 to which the configuration indirection unit is applied is a “namespace”. A “namespace” is used in the NVMe protocol to refer to a set of logical addresses that are accessible by the host 300. Multiple namespaces can be used to divide the memory 104 into isolated logical areas when multiple applications or virtual machines on the host 300 (or multiple hosts) can access the memory 104. In such “multi-tenancy” environment, namespaces can be used for data security to ensure that only authorized tenant(s) (and not other tenants) can access a given logical area. Namespaces can be used for other purposes as well.

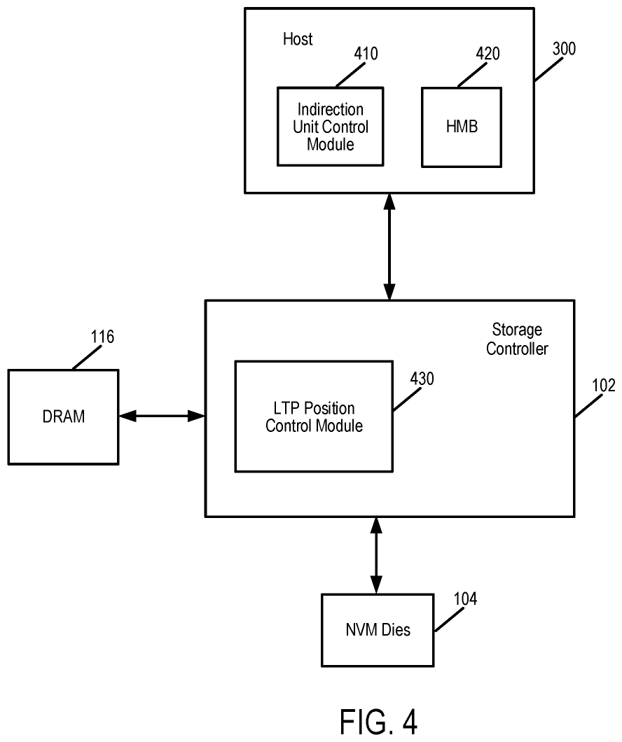

Turning again to the drawings, FIG. 4 is a block diagram of an example architecture of an embodiment. It should be understood that this is merely an example and that other architectures can be used. As shown in FIG. 4, in this example, the host 300 comprises an indirection unit control module 410 (e.g., implemented by the one or more processors 330 in the host 300) and a host memory buffer 420 (e.g., implemented by the one or more memories 340 in the host 300). As also shown in FIG. 4, the controller 102 comprises a logical-to-physical (LTP) position control module 430 (e.g., implemented by the one or more processors 138 in the host controller 102), which controls a position in the logical-to-physical address map according to the indirection unit.

In one embodiment, an indirection unit (e.g., in a portion of the memory 104, such as a namespace) can be configured (e.g., by the host 300, by the controller 102, and/or by another entity) during a format process of the data storage device 100 and remain static during the life of the data storage device 100. In another embodiment, the indirection unit can be modified (e.g., by the host 300, by the controller 102, and/or by another entity) during the lifetime of the data storage device 100.

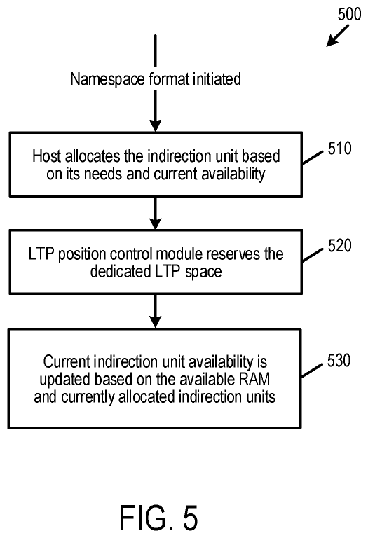

FIG. 5 is a flow chart 500 of a method of an embodiment for modifying an indirection unit during a namespace format. As shown in FIG. 5, after a namespace format is initialized, the host 300 allocates the indirection unit based on its needs and current availability (act 510). Next, the LTP position control module 430 reserves the dedicated LTP space (act 520). Then, the current indirection unit availability is updated based on the available RAM and currently-allocated indirection units (act 530).

The result of modifying the indirection unit of a namespace is that the logical-to-physical address map of the corresponding namespace will be modified in size. As such, it may be desired to keep track of the overall size of the logical-to-physical address map and make sure it does not exceed the limit. This can be done, for example, in the host 300 or in the controller 102. The location of this logic can reflect whether the information is passed from the host 300 to controller 102 only or whether there is an application program interface (API) between the controller 102 and the host 300 to pass the remaining size of the logical-to-physical address map and, hence, the currently-available indirection units for this namespace format.

The volatile memory type (e.g., DRAM) that is available to the data storage device 100 can also impact the decisions done about the indirection unit. For example, a data storage device with an available host memory buffer may have the currently-available host memory buffer size when it is making the inference about the available indirection unit sizes. However, the host memory buffer size itself may be modified, in theory, by the host 300, and this possibility can be a consideration of the overall system design.

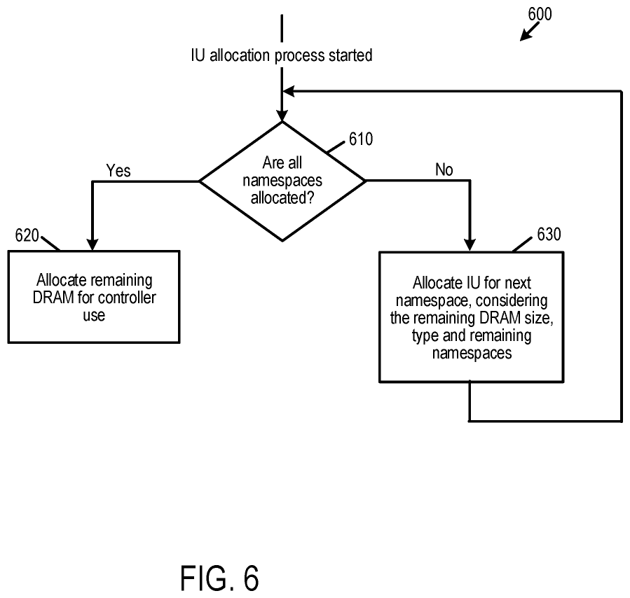

In one embodiment, the indirection unit allocation can be done in a loop that allocates indirection units per namespace according to the remaining volatile memory. When all namespaces are assigned an indirection unit, the remaining volatile memory can be considered for other uses. This embodiment will be illustrated in conjunction with the flow chart 600 in FIG. 6. As shown in FIG. 6, in this method, after the indirection unit allocation process has started, the controller 102 determines whether all of the namespaces are allocated (act 610). If the controller 102 determines that all of the namespaces are allocated, the controller 102 allocates the remaining DRAM for controller use (act 620). However, if the controller 102 determines that all of the namespaces are not allocated, the controller 102 allocates an indirection unit for the next namespace, considering the remaining size of the volatile memory, type, and remaining namespaces (act 630). After that, the method loops back to act 610.

In another embodiment, the system can analyze the currently-required size of the volatile memory for all or part of the logical-to-physical address map to be stored and consider the indirection units and the performance objectives per each namespace. The system can generate several namespaces, each with specific indirection units according to the overall available volatile memory. Then, the system can infer whether to use excess volatile memory that became available after the indirection unit size increase for another need, such as pre-loading data through read-look-ahead (RLA), storing management tables, storing various logs, or use as any other data or metadata buffer. The extra space may also be used by the host 300 through a Compute Express Link (CXL) or PCIe interface as an NVMe controller memory buffer (CMB),

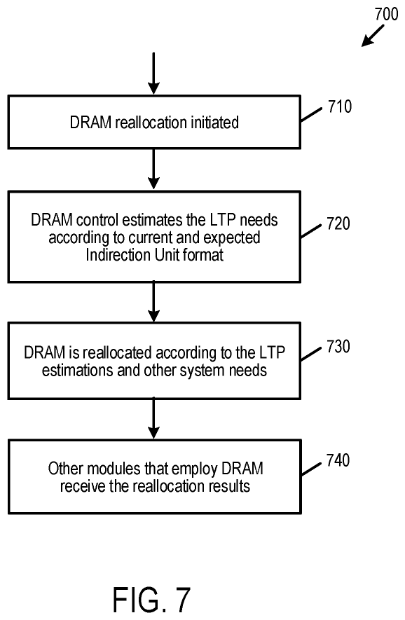

The process of volatile memory (here, DRAM) reallocation is described in the flow chart 700 of FIG. 7. As shown in FIG. 7, the controller 102 initiates DRAM allocation (act 710). Next, the DRAM control module estimates the LTP needs according to the current and expected indirection unit format (act 720). Then, the DRAM is reallocated according to the LTP estimations and other system needs (act 730). Finally, other modules that employ DRAM receive the reallocation results (act 740). The DRAM reallocation process can be initiated after some time elapses or upon some trigger. The trigger can include, for example, a namespace indirection unit modification (such as described in FIG. 5) that results in DRAM space freed or reserved.

These embodiments can be used in any suitable use case. For example, these embodiments can be used in a data storage device that stores both logs (which benefit from a relatively-small indirection unit) and host data (which benefit from a relatively-large indirection unit). In such a data storage device, almost all of the memory (e.g., 16TB) can be used with a 16KB indirection unit, while a small portion for the memory (e.g., up to 100MB) can be used for logging purposes with a 4KB indirection unit. This can enable having a logical-to-physical address map that is nearly four times smaller (e.g., ˜4GB) than the logical-to-physical address map of a regular device that uses a 4KB indirection unit for all of its capacity (e.g., 16GB). This also has a significant impact on the volatile memory that is dedicated for the task of storing the logical-to-physical address map. As can be seen by this example, these embodiments can allow for more efficient utilization of volatile memory for data storage devices that allow larger indirection units. This, in turn, can allow for better performance, power utilization, and cost savings.

Finally, as mentioned above, any suitable type of memory can be used. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are examples, and memory elements may be otherwise configured.

The semiconductor memory elements located within and/or over a substrate may be arranged in two or three dimensions, such as a two-dimensional memory structure or a three-dimensional memory structure.

In a two-dimensional memory structure, the semiconductor memory elements are arranged in a single plane or a single memory device level. Typically, in a two-dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and wordlines.

A three-dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three-dimensional memory structure may be vertically arranged as a stack of multiple two-dimensional memory device levels. As another non-limiting example, a three-dimensional memory array may be arranged as multiple vertical columns (e.g., columns extending substantially perpendicular to the major surface of the substrate, i.e., in the y direction) with each column having multiple memory elements in each column. The columns may be arranged in a two-dimensional configuration, e.g., in an x-z plane, resulting in a three-dimensional arrangement of memory elements with elements on multiple vertically stacked memory planes. Other configurations of memory elements in three dimensions can also constitute a three-dimensional memory array.

By way of non-limiting example, in a three-dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three-dimensional configurations can be envisioned wherein some NAND strings contain memory elements in a single memory level while other strings contain memory elements which span through multiple memory levels. Three-dimensional memory arrays may also be designed in a NOR configuration and in a ReRAM configuration.

Typically, in a monolithic three-dimensional memory array, one or more memory device levels are formed above a single substrate. Optionally, the monolithic three-dimensional memory array may also have one or more memory layers at least partially within the single substrate. As a non-limiting example, the substrate may include a semiconductor such as silicon. In a monolithic three-dimensional array, the layers constituting each memory device level of the array are typically formed on the layers of the underlying memory device levels of the array. However, layers of adjacent memory device levels of a monolithic three-dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three-dimensional memory arrays. Further, multiple two-dimensional memory arrays or three-dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three-dimensional structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

What is claimed is:

1. A data storage device comprising:
a memory; and
one or more processors, individually or in combination, configured to:
receive, from a host, a request to change a size of an indirection unit for at least a part of the memory; and
in response to receiving the request, change the size of the indirection unit for the at least the part of the memory.

2. The data storage device of claim 1, wherein the one or more processors, individually or in combination, are further configured to use different indirection units in different parts of the memory at a given time.

3. The data storage device of claim 1, wherein the at least the part of the memory comprises a namespace.

4. The data storage device of claim 1, wherein the one or more processors, individually or in combination, are further configured to provide the host with a plurality of sizes of the indirection unit for selection.

5. The data storage device of claim 1, wherein:
changing the size of the indirection unit increases a size of a logical-to-physical address map; and
the one or more processors, individually or in combination, are further configured to track the size of the logical-to-physical address map and prevent the size of the logical-to-physical address map from exceeding a limit.

6. The data storage device of claim 1, wherein the size of the indirection unit for the at least the part of the memory is constrained by an amount of volatile memory available to store a logical-to-physical address map.

7. The data storage device of claim 1, wherein the one or more processors, individually or in combination, are further configured to:
read at least a portion of a logical-to-physical address map; and
store the at least a portion of a logical-to-physical address map in volatile memory in the data storage device and/or in volatile memory in the host.

8. The data storage device of claim 1, wherein the one or more processors, individually or in combination, are further configured to:
store at least a portion of a logical-to-physical address map in volatile memory;
determine whether all of a plurality of namespaces have been allocated;
in response to determining that all of the plurality of namespaces have been allocated, allocate remaining volatile memory for use by the one or more processors; and
in response to determining that all of the plurality of namespaces have not been allocated, allocate an indirection unit for a next namespace, considering at least one of a remaining size of the volatile memory, a namespace type, and/or remaining namespace(s).

9. The data storage device of claim 1, wherein the indirection unit comprises a minimal recommended write unit size.

10. The data storage device of claim 1, wherein different sizes of indirection units are used for logs and host data.

11. The data storage device of claim 1, wherein the memory comprises a three-dimensional memory.

12. A method comprising:
performing in a data storage device comprising a memory:
providing a host with a plurality of choices for a definition of an amount of data written to or read from a logical address in at least a part of the memory;
receiving, from the host, a selection of one of the plurality of choices; and
in response to receiving the selection, changing the definition of the amount of data based on the selection.

13. The method of claim 12, further comprising:
after the definition of the amount of data has been changed, updating the plurality of choices based, at least in part, on availability of volatile memory in the data storage device and/or host to store at least a portion of a logical-to-physical address map.

14. The method of claim 12, further comprising:
performing a loop in which a definition of an amount of data written to or read from a logical address in each of a plurality of other parts of the memory is changed, wherein the definitions of the amounts of data for the plurality of other parts of the memory are each determined based on an amount of volatile memory available to store at least a part of a logical-to-physical address map.

15. The method of claim 12, further comprising:
after the definition of the amount of data has been changed:
storing at least a portion of a logical-to-physical address map in volatile memory, wherein a size of the at least the portion of the logical-to-physical address map depends on the definition of the amount of data; and
using remaining space in the volatile memory for storing data other than the portions of the logical-to-physical address map.

16. The method of claim 12, wherein the amount of data written to or read from the logical address comprises an indirection unit.

17. The method of claim 16, wherein the indirection unit comprises a minimal recommended write unit size.

18. The method of claim 16, further comprising using different sizes of indirection units are for logs and host data.

19. The method of claim 12, further comprising:
allocating volatile memory;
generating an estimate of an amount of volatile memory needed to store at least a portion of a logical-to-physical address map;
re-allocating the volatile memory based on the estimate; and
allowing remaining space in the volatile memory to be used for a purpose other than logical-to-physical address-map storage.

20. A data storage device comprising:
a memory; and
means for re-configuring a size of a storage indirection unit after production of the data storage device, wherein the size of the storage indirection unit is not hard-coded in the data storage device.
